(19) United States
(12) Patent Application Publication
(10) Pub. No.: US 2017/0039557 A1
(43) Pub. Date: Feb. 9, 2017

(54) VIRTUAL POINT OF SALE

(71) Applicant: HEWLETT PACKARD ENTERPRISE DEVELOPMENT LP, Houston, TX (US)

(72) Inventor: Wade M. MURPHY, Wellington (NZ)

(73) Assignee: HEWLETT PACKARD ENTERPRISE DEVELOPMENT LP, Houston, TX (US)

(21) Appl. No.: 15/303,501

(22) PCT Filed: Apr. 28, 2014
(86) PCT No.: PCT/US2014/035666

§ 371 Date: Oct. 11, 2016

(51) Int. Cl. G06Q 20/38; G06Q 20/40

(52) U.S. Cl. CPC G06Q 20/3829; G06Q 20/4012

(57) ABSTRACT

A virtual point of sale (POS) can include logic, firmware and executable instructions to create a secure session between the virtual POS device and a host POS. The virtual POS can receive payment credentials according to a near field communication (NFC) compliant protocol and generate an encrypted PIN block. The virtual POS device can encapsulate the PIN block with payment credentials and transaction details. The encapsulated and encrypted PIN block is sent to an external interface in association with a payment authorization request. An approval or denial of the payment authorization request is received at the virtual POS device.

### BACKGROUND

Electronic commerce (eCommerce) activity continues to grow at a phenomenal rate; however, providing secure payment for eCommerce transactions continues to present challenges to both merchants and consumers. One way that these challenges are presented is as a risk of fraudulent activity to the merchant and consumers. This risk is represented through higher transaction fees for online transactions and merchant liability for resulting fraud where the user's card is not present at the point of sale (POS).

### BRIEF DESCRIPTION OF THE DRAWINGS

FIG. 1 illustrates a diagram of an example of a system for electronic funds transfer at a virtual POS according to the present disclosure.

FIG. 2 illustrates a diagram of an example computing device according to the present disclosure.

FIG. 3 illustrates a diagram of an example of a logical architecture according to the present disclosure.

FIGS. 4A and 4B illustrate a diagram of an example process flow according to the present disclosure.

FIGS. 5A-5C illustrate an example user interface (UI), e.g., screen, flow according to the present disclosure.

FIG. 6 illustrates an example flow chart of a method for electronic funds transfer at a virtual POS according to the present disclosure.

### DETAILED DESCRIPTION

Facilitating secure eCommerce transactions can be difficult due to a number of factors. One such factor is that eCommerce transactions are frequently conducted as card-not-present (CNP) transactions. In a CNP transaction, the physical card is not present for inspection by the merchant. This increases the chance for fraud or misappropriation of a consumer's card data because the merchant has no ability to compare, for example, the cardholder's signature to the signature on the back of the physical card. In addition, cardholder data is often transferred as cleartext in traditional CNP eCommerce transactions. This practice makes CNP transactions vulnerable to, for example, replay attacks. As the popularity and prevalence of eCommerce transactions continues to grow, the risk of cardholder data being exposed to fraudulent activity also rises.

Currently available methods which attempt to protect online payment information in eCommerce transactions suffer from a number of shortcomings. Examples of such shortcoming include; not implementing a reliable two-factor authentication process, transferring a greater amount of user data and/or information than is desirable or than is transferred in a traditional retail point of sale (POS) credit card present (CP) transaction, and being tethered to particular hardware and/or chipsets. As used herein, a two-factor authentication process intends both actual, physical possession of an item, e.g., using what is physically present (card, token, mobile phone, etc.), together with knowledge of certain unique information, e.g., using information uniquely known to an authorized user such as a personal identification number (PIN), etc.

Some examples of methods available for protecting payment information in online transactions include one time passwords, which enjoyed little popularity, and temporary short message service codes, which have been declared unsafe by the telecommunications industry. These approaches are ineffective for exacting secure payment credential transfer. As used herein, “payment credentials” means any information used to identify an account from which a payment can be made, e.g., a primary account number of a credit or debit card, payment token(s), smartphone information, etc. Still other examples of presently available methods include stand-alone hardware devices, e.g., in association with chip authentication programs (CAPs), which may be incompatible with banking and credit card issuing institutions or hardware based security technology which tie the user to particular chip set suppliers or hardware form factors.

In contrast, embodiments of the present disclosure can allow for the secure retail POS experience to be replicated within the online, eCommerce domain. Embodiments implement a two-factor authentication to effect a card present (CP) type transaction in a virtual retail POS solution which enables a secure retail experience from a consumer endpoint device, such as a PC, Tablet or mobile phone with an online (e.g., via the internet) merchant (e.g., eCommerce merchant). As used herein, the term “virtual POS” is intended to mean a transaction event which mimics a physically present, transaction event as if conducted physically in person between a merchant and a purchaser in the same location, e.g., physical retail store. Hence, a virtual POS includes the online, e.g., Internet, purchase of goods through a website of an online retailer, e.g., eCommerce merchant.

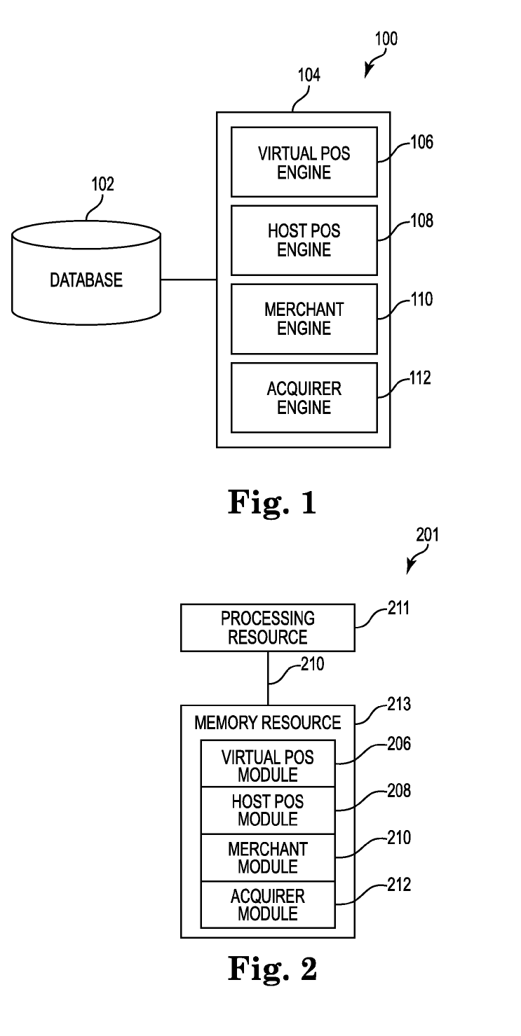

FIG. 1 illustrates a diagram of an example of a system 100 for electronic funds transfer at a virtual POS according to the present disclosure. As shown in the example of FIG. 1, the system 100 can include a database 102 accessible by and in communication with a plurality of electronic transaction, e.g., electronic funds transfer system engines 104. The electronic transaction system engines 104 can include a virtual POS engine 106, a host POS engine 108, a merchant web server engine 110, and an acquirer engine 112, etc. The system 100 can include additional or fewer engines than illustrated to perform the various functions described herein and embodiments are not limited to the example shown in FIG. 1. The system 100 can include hardware, e.g., in the form of transistor logic and/or application specific integrated circuitry (ASICs), firmware, and software, e.g., in the form of machine readable and executable instructions (program instructions (programming) stored in a machine readable medium (MRM)) which in cooperation can form a computing device as discussed in connection with FIG. 2.

The plurality of engines, e.g., 106, 108, 110, 112, as used herein can include a combination of hardware and software, e.g., program instructions, but at least includes hardware that is configured to perform particular functions, tasks and/or actions. The engines shown in FIG. 1 are used to facilitate a secure two-form authentication, electronic transaction between a near field communication (NFC) enabled, e.g., contactless, payment device and an eCommerce merchant at a virtual POS environment.

For example, the virtual POS engine 106 can include hardware and/or a combination of hardware and program instructions to register selection of an item for electronic purchase online via the Internet through a merchant engine 110, acquire payment credentials, encrypt payment credentials, communicate and exchange information with a host POS engine 108, request payment authorization from an acquirer engine 112, and receive payment approval or denial for the authorization request.

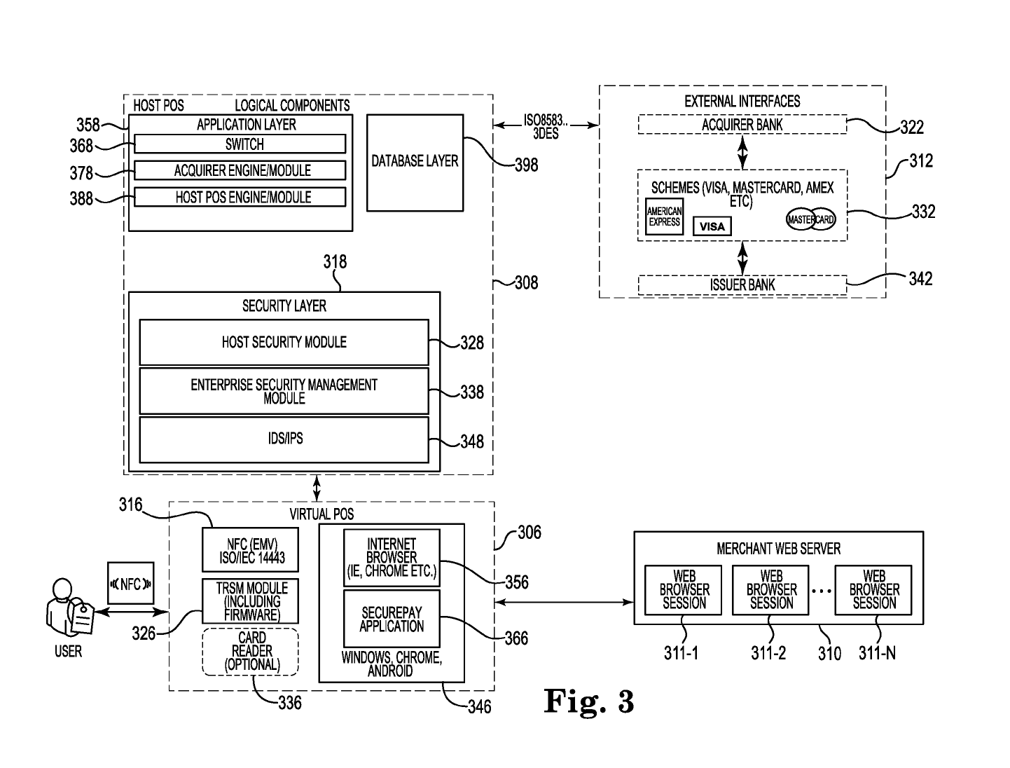

The host POS engine 108 can include hardware and/or a combination of hardware and program instructions to receive information, e.g., data, from the virtual POS engine 106. For example, the host POS engine 108 can communicate securely with the virtual POS engine 106 to transport payment credentials to an acquirer engine 112. Additionally, as described more in connection with FIG. 3, the host POS engine 108 can employ one or more security modules and use a Derived Unique Key Per Transaction (DUKPT) key management scheme to ensure secure communication sessions with the virtual POS engine 106, e.g., consumer endpoint device (PC, Tablet, mobile phone, etc. (also referred to as a “terminal”). As used herein, secure communication sessions (or “secure terminal sessions”) mean encrypted communication sessions between the engines and/or modules (e.g., the host POS engine 108 and the virtual POS engine 106) and include secure transactions conducted between the engines and/or modules.

The merchant engine 110 can include hardware and/or a combination of hardware and program instructions to present items electronically for purchase in association with an online, eCommerce merchant website. The merchant engine can also function to check compatibility, e.g., to determine NFC payment capability, with the virtual POS engine 106, e.g., consumer endpoint device (terminal). For example, the merchant engine 110 can function to detect what payment options a virtual POS engine 106 may or may not support, e.g., whether the virtual POS engine 106 supports CNP and contactless (NFC) payment mechanisms or just CNP only. The merchant engine 110 may further initialize an electronic session to exchange information with the host POS engine 108.

The acquirer engine 112 can include hardware and/or a combination of hardware and program instructions to receive a payment authorization request from the virtual POS engine 106. The term “acquirer”, as used herein, may be a third party entity associated with an electronic transaction. An acquirer may have a business relationship with a particular merchant and be referred to as a “merchant acquirer”. Additionally, an acquirer may be a financial intermediary that can assume the financial risk of transactions conducted by a merchant and may effect settlement on behalf of the merchant. In some instances an acquirer may have a relationship with both an issuing bank of a payment card and with a given merchant; however, in some instances an acquirer and issuing bank may be the same entity. The term “acquirer engine” is an engine performing tasks, functions and/or actions in connection with the acquirer, third party entity. The acquirer engine 112 can function to determine a scheme, e.g., Visa®, Mastercard®, Amex®, etc., associated with an issuer of a payment card, e.g., an issuing bank. By way of example, the acquirer engine may determine a card scheme based on a bank identification number (BIN) or the issuer identification number (IIN) associated with a payment card.

The embodiments are not limited to the example engines shown in FIG. 1 and one or more engines described may be combined or may be a sub-engine of another engine. Further, the engines shown may be remote from one another in a distributed computing environment, cloud computing environment, etc.

FIG. 2 illustrates a diagram of an example computing device 201 according to the present disclosure. The computing device 201 can utilize hardware, software (e.g., program instructions), firmware, and/or logic to perform a number of functions described herein. The computing device 201 can be any combination of hardware and program instructions configured to share information. The hardware can, for example, include a processing resource 211 and a memory resource 213 (e.g., computer or machine readable medium (CRM/MRM), database, etc.). A processing resource 211, as used herein, can include one or more processors capable of executing instructions stored by the memory resource 213. The processing resource 211 may be implemented in a single device or distributed across multiple devices. The program instructions (e.g., computer or machine readable instructions (CRI/MRI)) can include instructions stored on the memory resource 213 and executable by the processing resource 211 to perform a particular function, task and/or action (e.g. request payment authorization, etc.).

The memory resource 213 can be a non-transitory machine readable medium, include one or more memory components capable of storing instructions that can be executed by a processing resource 211, and may be integrated in a single device or distributed across multiple devices. Further, memory resource 213 may be fully or partially integrated in the same device as processing resource 211 or it may be separate but accessible to that device and processing resource 211. Thus, it is noted that the computing device 201 may be implemented on a participant device, on a server device, on a collection of server devices, and/or a combination of a participant, e.g., user/consumer endpoint device, and one or more server devices as part of a distributed computing environment, cloud computing environment, etc.

The memory resource 213 can be in communication with the processing resource 211 via a communication link (e.g., a path) 210. The communication link 210 can provide a wired and/or wireless connection between the processing resource 211 and the memory resource 213.

In the example of FIG. 2, the memory resource 213 includes a virtual POS module 206, a host POS module 208, a merchant module 210, and an acquirer module 212. As used herein a module can include hardware and software (e.g., program instructions), but includes at least program instructions that can be executed by a processing resource, e.g., processing resource 211, to perform a particular task, function and/or action. The plurality of modules 206, 208, 210, 212 may be combined or may be sub-modules of other modules. As shown in FIG. 2, the virtual POS module 206, the host POS module 208, the merchant module 210, and the acquirer module 212 can be individual modules located on one memory resource. However, embodiments are not so limited and a plurality of modules, e.g., 206, 208, 210, 212, may be located at separate and distinct memory resource locations, e.g., in a distributed computing environment, cloud computing environment, etc.

Each of the plurality of modules 206, 208, 210, 212 can include instructions that when executed by the processing resource 211 can function as an engine such as the engines described in connection with FIG. 1. For example, the virtual POS module 206 can include instructions that when executed by the processing resource 211 can function as the virtual POS engine 106 shown in FIG. 1. The host POS module 208 can include instructions that when executed by the processing resource 211 can function as the host POS engine 108 shown in FIG. 1. The merchant module 210 can include instructions that when executed by the processing resource 211 can function as the merchant engine 110 shown in FIG. 1. Additionally, the acquirer module 212 can include instructions that when executed by the processing resource 211 can function as the acquirer engine 112 shown in FIG. 1.

Embodiments are not limited to the example modules shown in FIG. 2 and in some cases a number of modules can operate together to function as a particular engine. Further, the engines and/or modules of FIGS. 1 and 2 can be located in a single system and/or computing device or reside in separate distinct locations in a distributed network, cloud computing, enterprise service environment (e.g., Software as a Service (SaaS)) environment, etc.

FIG. 3 illustrates an example of a logical architecture for electronic funds transfer at a virtual POS according to the present disclosure. As shown in FIG. 3, a virtual POS 306 can communicate with a host POS 308. The virtual POS 306 may comprise a computing device (e.g., PC, computer tablet, mobile phone, etc.) including a virtual POS engine as described in connection with FIG. 1 or a virtual POS module in communication with a processing resource as described in connection with FIG. 2. The host POS 308 may comprise a computing device including a host POS engine and an acquirer engine as described in connection with FIG. 1 or a host POS module and an acquirer module in communication with a processing resource as described in connection with FIG. 2. As shown in FIG. 3, the virtual POS 306 can communicate with a merchant web server 310 and the host POS 308. The host POS 308 can communicate with the virtual POS 306, the merchant web server 310, and external interfaces 312 to facilitate electronic funds transfer at the virtual POS 306. As used herein, external interfaces include connections to servers and other third party networks such as financial institutions, etc. The merchant web server 310 may comprise a computing device including a merchant engine as described in connection with FIG. 1 or a merchant module in communication with a processing resource as described in connection with FIG. 2. In addition, the merchant web server 310 may support a plurality of web browser sessions 311-1, . . . , 311-N that may be accessed from the virtual POS 306.

By way of example, and not by way of limitation, the virtual POS 306, host POS 308 and merchant web server 310 may communicate with one another using, for example, HTTP, secure socket layer (SSL), transport layer security (TLS), triple data encryption standard (TDES or 3DES), etc.. The host POS 308 may communicate with the external interfaces 312 using ISO8583 and 3DES communication protocols; however, communication protocols between the host POS 308 and external interfaces 312 are not so limited and could include other communication protocols including emerging protocols such as ISO 20022, for example. The virtual POS 306 is configured to support the EMV® contactless specifications for payment systems as published by EMVco, e.g., possess NFC enabled, contactless payment capabilities 316. As used herein EMV® stands for Europay®, Visa®, Mastercard® and defines a global standard for inter-operation of integrated circuit cards (e.g., IC cards or “chip cards”). EMVco is an organizational body that manages, maintains and enhances EMV® integrated circuit card specifications for chip-based payment cards and acceptance devices.

As shown in FIG. 3, the virtual POS 306 includes a component 316 (e.g., device, engine and/or module) conforming to the NFC (EMV®) ISO/IEC 14443 standard such that an NFC enabled, contactless payment device (e.g., payment card, token, or mobile phone) may be read when presented to component 316 of virtual POS 306. The virtual POS 306 will support all applicable certifications, regulatory and payment body standards for terminals, including, but not restricted to, PCI PED, PCI PTS, EMV® Level 1 & Level 2, ISO/ANSI, FCC, etc. In addition, the virtual POS 306 will support a personal identification number (PIN) entry device (PED), e.g., secure track pad, touch pad/screen or other consumer user interface (UI).

As shown in FIG. 3, the virtual POS 306 can include a Tamper-Resistant Security Module (TRSM module 326), including firmware. As used herein a TRSM is a security module that is tamper-resistant (to make intrusion difficult), tamper-evident (to make intrusion attempts evident), and tamper-responsive (to detect an intrusion attempt and destroy contents in the process). As such, the TRSM module may be housed in a device that incorporates physical protections to prevent compromise of cryptographic security parameters (CSP) contained therein. In the example of FIG. 3, the virtual POS 306 may optionally support additional payment card readers such as embedded or tethered EMV® chip card 336 or magnetic stripe readers.

Further, the virtual POS 306 can include multiple different hardware and software operating environments 346, e.g., Windows®, Linux®, Chromium®, OS X®, and/or Android® operating systems; and various internet browser applications 356, e.g., Internet Explorer® (IE), Chrome®, Mozilla Firefox®, Opera®, Safari®, etc. A virtual POS engine or module 366, as described in connection with FIGS. 1 and 2 is shown present in the hardware and software environment 346 of the virtual POS 306.

As shown in FIG. 3, the host POS 308 can include a security layer component 318, an application layer component 358, and a database layer component 398. The security layer component 318 can include a host security module (HSM)/appliance 328, an enterprise security management module/appliance 338 and an intrusion detection system (IDS) and/or intrusion prevention system (IPS) module/appliance 348. As noted above, the host POS 308 can communicate with the virtual POS 306 using, for example, HTTP, secure socket layer (SSL), transport layer security (TLS), 3DES, etc. In this manner, the host POS 308 may be remote from the virtual POS 306 and exist in a cloud computing environment. The host POS 308 may receive NFC enabled, contactless payment card information direct from the virtual POS 306 thus removing sensitive payment card information from the online merchant environment 310. The host POS 308 is assumed to be payment card industry data security standard (PCI DSS) compliant.

The application layer to the host POS 308 can include a switching mechanism 368 to route transaction network traffic, an acquirer engine and/or module 378 such as described in connection with FIGS. 1 and 2, and a host POS engine and/or module 388 as described in connection with FIGS. 1 and 2. As described above, in connection with the virtual POS 306, the acquirer engine and/or module 378 and the host POS engine and/or module 388 is not limited to any particular hardware and/or software operating environment. As noted above, the acquirer engine and/or module 378 can communicate with the external interfaces entity 312 via a switch 368 using, for example, ISO 8583/3DES and the host POS engine and/or module 388 can communicate with the virtual POS 306 using, for example, HTTPS/SSL/TLS/3DES.

As shown in FIG. 3, the external interface 312 can include an acquirer bank entity 322 and/or an issuer bank 342 both of which may include interfaces to payment card provider payment schemes 332, e.g., Visa®, Mastercard®, Amex®, etc., associated with an issuer of a payment card, e.g., an issuing bank.

In operation, the HSM 328 in the host POS 308 will include instructions executable by a processing resource to create, access and maintain a Base Derivation Key (BDK). The BDK can be used to create an Initial PIN Encryption Key (IPEK) which, accompanied by a key serial number, can be provided to the virtual POS 306, e.g., consumer endpoint device. In this example, the TRSM module 326 of the virtual POS 306 is provided in compliance with the ISO 9564 standard and will contain a unique cryptographic key, e.g., IPEK, based on the HSM module 328 BDK. The IPEK can be provided to the virtual POS 306 at point of manufacture such that each virtual POS 306, e.g., consumer endpoint device will have a unique cryptographic key, e.g., an IPEK accompanied by a key serial number. A subsequent Derived Unique Key Per Transaction (DUKPT), e.g., working key, will be used by the host POS 308 as a method for securing communication sessions with a given virtual POS 306. In some embodiments the DUKPT is double the bit length of the unique cryptographic key, e.g., the unique cryptographic key is 16 hexadecimal character number and the DUKPT is a 32 hexadecimal character number.

The virtual POS 306 will contain applicable integration firmware and application program interface (API) software 366, e.g., program instructions, to create a secure connection, e.g., session, between the virtual POS 306 and the host POS 308 which will have the HSM 328 containing the BDK. As used herein, a secure session will ensure a validity of the virtual POS 306, ensure message transport encryption, e.g., 3DES, per ANSI x9.52 standards, ensure message transport authentication, e.g., via a message authentication code (MAC), and enable a secure, e.g., encrypted PIN block to be created per ANSI x9.8 and ISO 9564.

Additionally, the virtual POS 306 integration firmware and API software 366 can include instructions that are executed to: apply a correct operating system kernel applicable to a scheme card brand, e.g., Visa®, Mastercard®, Amex®, etc.; prompt for contactless device (NFC) read, PIN entry, etc.; enrich an online purchase transaction with transaction amount, merchant ID, currency code, country code, merchant type, etc.; effect ISO 8583 messaging, e.g., message type indicator (MTI) x8xxx, x1xxx, x4xxx messages, etc.; handle exception processing; and enable firmware updates and manual encryption key entry via an administrative function.

The host POS 308 will additionally execute instructions to securely communicate with the virtual POS 306 and transport payment and card credentials including the PIN block. The host POS 308 will also store the virtual POS 306 host IP address and port number as may be dynamically set by the eCommerce merchant on the eCommerce merchant web server 310. This will effect routing of payments acquired via the virtual POS 306. The host POS 308 will similarly be able to: effect ISO 8583 messaging, e.g., message type indicator (MTI) x8xxx, x1xxx, x4xxx messages, etc.; effect transaction routing to merchant acquiring bank 322 or card scheme brand 332 via external interface 312; may effect settlement on behalf of the merchant; and can log transactional activity.

The merchant web server 310 shown in the example of FIG. 3 can include a merchant engine and/or module, e.g., in the form of a servlet (instructions), API, etc. as described in connection with FIGS. 1 and 2, to cause the system to effect a virtual POS 306 terminal check and present CNP and contactless (NFC) options or CNP option only. The merchant engine and/or module can cause the system to initialize a session between the virtual POS 306 and the host POS 308, e.g., capture source internet protocol (IP) address, route terminal host IP address (destination address), and reference the host POS 308. Additionally, the merchant engine and/or module may execute instructions to redirect to a CNP entry page where a virtual POS 306 initialization fails, e.g., the DUKPT doesn't match with a key held in the HSM 328 on the host POS 308.

Further functionality associated with a merchant engine and/or module can include executing instructions to: add date/time, system trace audit number (STAN), currency code, country code, transaction amount, merchant type information, merchant ID, etc. to an ISO 8583 MTI 0100 (e.g., authorization) message; provide a successful and unsuccessful hand off, e.g., transaction approved/declined, messages to the virtual POS 306; support error/exception conditions; and perform transaction logging.

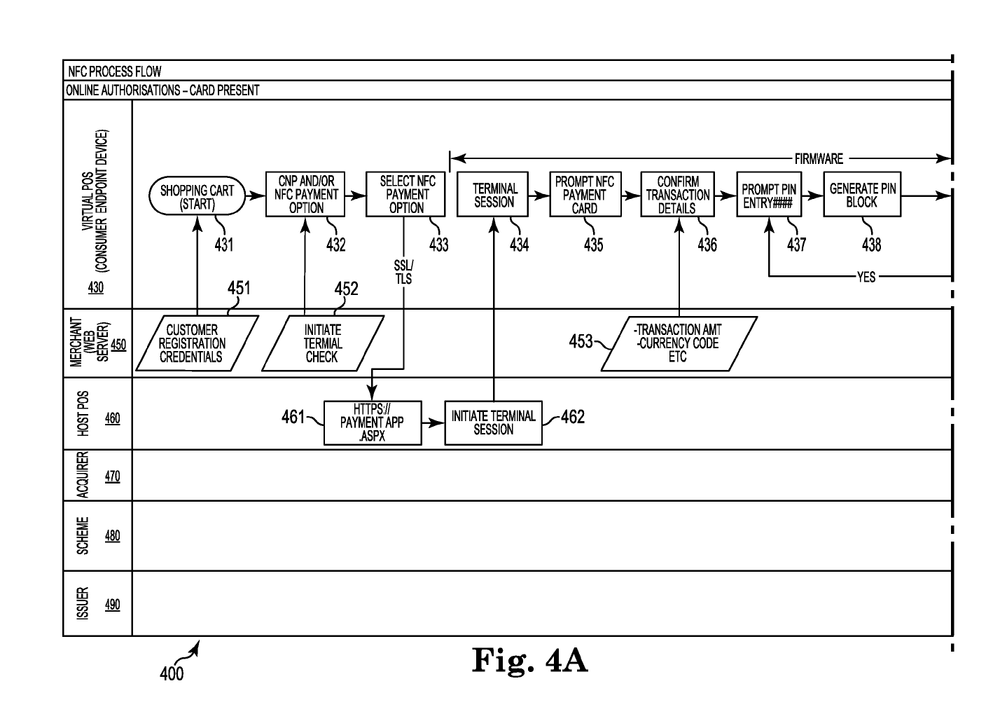

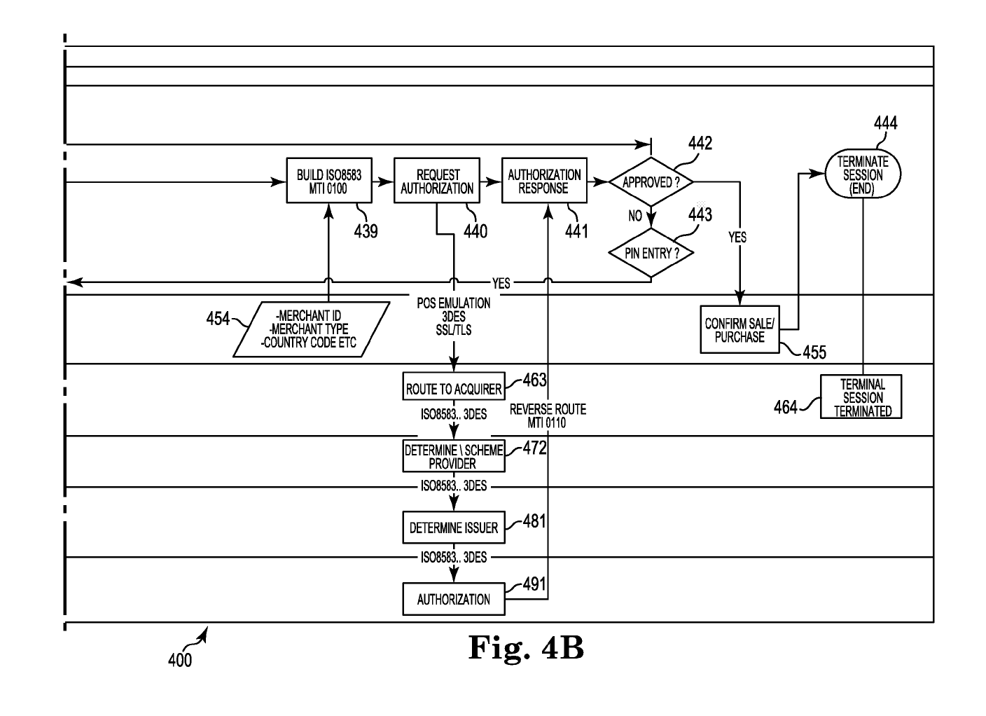

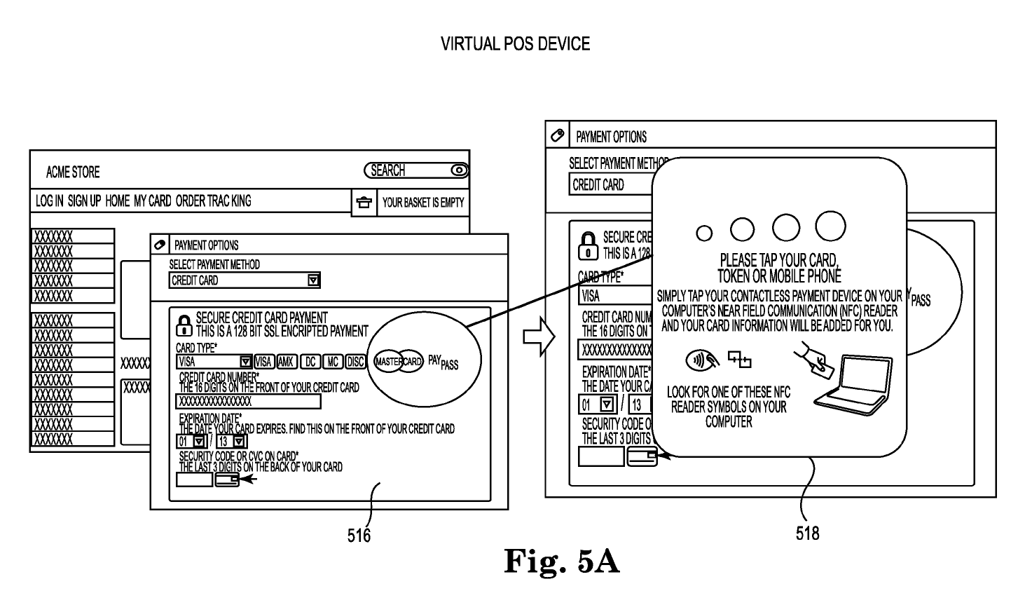

FIGS. 4A and 4B illustrate an example process flow 400 for electronic funds transfer at a virtual POS according to the present disclosure. In particular, the process flow example given in FIGS. 4A and 4B relates to an NFC enabled, card present electronic transaction, e.g., an online, eCommerce electronic fund transfer. In connection with the process flow of FIGS. 4A and 4B, some inputs can be received to a user interface (UI), e.g., graphical user interface (GUI), of a virtual POS device, e.g., the virtual POS device 306 (PC, Tablet, mobile phone, etc.) as shown and described in connection with FIG. 3. Other actions described in the process flow, however, can result from program instructions executing to cause other components, e.g., engines and/or modules in a system, to respond further, including executing other instructions.

That is, while certain inputs may be received to a UI to cause a system to respond with certain actions shown, other actions shown may result from the execution of instructions associated with engines and/or modules, e.g., the engines and modules described in connection with FIGS. 1-3, causing additional hardware and/or software, e.g., engines and/or modules to perform the actions, functions and/or tasks described herein. Additionally, some inputs received to a UI of a virtual POS are described with reference to a user's action for ease of illustration. Embodiments, however, are not intended to depend on user interaction with a virtual POS device.

Further, in the example shown in FIGS. 4A and 4B, a plurality of entity associated devices, engines and/or modules are shown. For ease of description, the entity associated devices, engines and/or modules can be discussed as participating actors to an eCommerce electronic fund transfer. The entities shown in the process flow example of FIGS. 4A and 4B include; a virtual POS 430 (e.g., consumer endpoint device), a merchant web server 450, a host POS 460, and acquirer 470, a scheme 480, and an issuer 490. Embodiments, however, may include fewer or additional entity associated devices, engines and/or modules. Some entity associated devices, engines and/or modules may, in certain embodiments be combined or have the functions, tasks and/or actions they perform split further among additional entity associated actors.

At 431 in FIG. 4A, a user of an electronic, online eCommerce merchant website may initiate a transaction by placing items to purchase in a digital, e.g., virtual, shopping cart. As used herein, a “user” can mean a person performing or executing interactions, or a plurality of interactions, on the virtual POS 430; however, it is to be understood that such interactions could also be performed or carried out by any combination of hardware and/or software configured to perform such interactions. At 451 a merchant web server 450 may execute instructions to provide a user, e.g., customer, registration credentials to the virtual POS 430, e.g., consumer endpoint device. As described above in connection with merchant web server 310 in FIG. 3, the merchant web server 450 may initialize an online, eCommerce session by executing instructions to capture a source IF address, route virtual POS (terminal) host IF address, and reference a host POS as part of a cloud computing, enterprise service, e.g., a software as a service (SaaS) application in a cloud computing environment.

At 452 the process flow can include a merchant web server 450 entity executing instructions to perform a terminal check 452 of the virtual POS 430 to determine payment capability of the virtual POS 430 (e.g., CNP and contactless (NFC) options or CNP option only). At 432, instructions associated with the virtual POS 430 can execute to present, e.g., offer, via a UI display a card not present (CNP) and/or card present (CP) near field communication (NFC) payment options. In some examples, payment capability can be determined by the merchant web server 450 via an application program interface (API) or servlet. As described above in connection with FIGS. 1-3, instructions can be executed in association with a host POS, e.g. 308 in FIG. 3 (having a BDK in an HSM 328) to receive from the virtual POS, e.g., 306 in FIG. 3, a DUKPT (working key) to create a secure communication session between the virtual POS 430 and a host POS application, e.g., 388 in FIG. 3.

At 433 the virtual POS 430 executes instruction to prompt a user to select a payment option, e.g., from among the CNP and/or NFC payment options. At 462, the merchant web server 450 entity may execute instructions to initiate a terminal session 462 between the virtual POS 430 and a host POS 460. At 435 the process flow can include the virtual POS 430 executing instructions to present, e.g., display, via, e.g., a UI, a prompt to enter payment credentials 435, e.g., payment card information. As used herein, payment card can include a contactless payment device such as a credit card, debit card, payment card, token, mobile phone, and/or any device or item that may be used to purchase goods or services. In operation, payment credentials may be received at the virtual POS 430 via NFC, as described above in connection with FIGS. 1-3. For example, instructions can be executed in association with a virtual POS, e.g., 306 in FIG. 3 to receive payment credentials via, e.g., a NFC enabled device 316. In addition, the virtual POS 430 may execute instructions to provide visual and/or audio confirmation that the payment credentials have, or have not, been received by the virtual POS 430.

At 453 the merchant web server 450 entity may execute instructions to forward transaction details, e.g., the amount of the transaction, a currency code for the transaction, etc. for receipt at the virtual POS 430. Instructions associated with the virtual POS 430 can execute to present, e.g. prompt, via a UI display, an option to confirm transaction details 436.

At 437 the process flow can include the virtual POS 430 executing instructions to receive PIN entry 437 from, e.g. a user. In operation, the virtual POS 430 may execute instructions to present, e.g., prompt for PIN entry to the virtual POS 430. In some examples, a PIN may be entered via a PIN entry device (PED), e.g., secure track pad, touch screen, touch pad, etc. in communication with the virtual POS 430. As described above in connection with FIGS. 1-3, instructions can be executed in association with the virtual POS, e.g., 306 in FIG. 3 to receive PIN entry via, e.g., a PED.

At 438 the process flow can include the virtual POS 430 executing instructions to encrypt the PIN, e.g., per ANSI x9.8 and ISO 9564, to generate an encrypted PIN block 438. At 454, instructions associated with the merchant web server 450 entity can execute to generate merchant information 454 necessary, e.g., country code, merchant type, merchant ID, etc. to complete, e.g., the ISO 8583 message format. At 439, instructions associated with the virtual POS 430 can execute to; add the merchant information 454 to the PIN block; and build an ISO 8583, e.g. MTI 0100 authorization request 439. As described above in connection with FIGS. 1-3, instructions can be executed in association with the virtual POS, e.g., 306 in FIG. 3 to build the ISO 8583 MTI 0100 authorization request 439. In addition, the virtual POS 430 may execute instructions to request authorization 440 for the electronic funds transfer.

Instructions executed by the virtual POS 430 may route 463 the authorization request 440 to an acquirer 470 via the host POS 460. The acquirer 470 may receive the authorization request 440 and execute instructions to determine the card scheme brand 472, e.g., MasterCard®, Visa®, Amex, etc. using, for example, the card BIN or IIN. Instructions associated with the scheme 480 execute to determine the issuer 481, e.g., a bank that offers branded (e.g., MasterCard®, Visa®, Amex®, etc.) payment cards to consumers. In addition, the issuer 490 may provide authorization 491 for the transaction and route an authorization response 441, e.g., ISO 8583 MTI 0110, to be received by the virtual POS 430. If the authorization 491 is not approved 443, e.g., an incorrect PIN was received by the virtual POS 430, the virtual POS 430 may execute instructions to receive the PIN again, e.g., via a UI prompting a user to re-enter PIN information 437. If the authorization 491 is approved 442, instructions associated with the virtual POS 430 may execute to confirm the transaction, e.g., a sale or purchase 455, with the merchant web server 450. In addition, the virtual POS 430 may execute instructions to terminate the session 444 with the host POS 460.

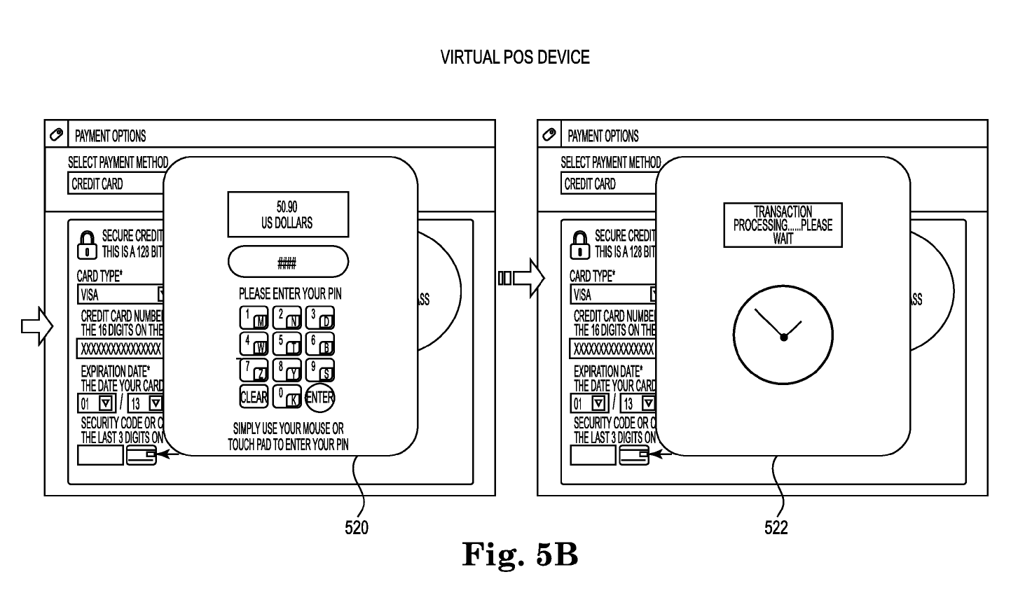

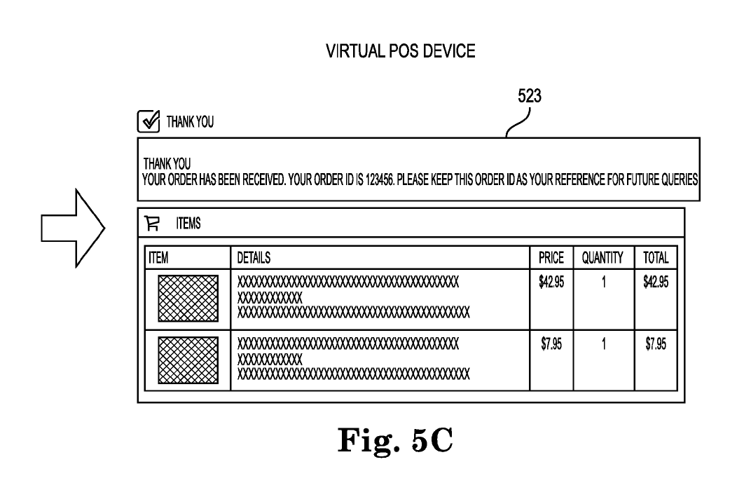

FIGS. 5A-5C illustrate an example screen flow of an example user interface (UI) for electronic funds transfer at a virtual POS according to the present disclosure. The UI can include a plurality of working display areas presented visually and/or audibly to a user and can include a plurality of actuable areas. For example, the UI can include working display areas in the form of a transaction processing message portion 522 and a transaction confirmation portion 523 to a display screen of the UI. The UI can also include actuable areas such as payment option panel 516, a payment input panel 518, and a PIN entry panel 520. In addition, the UI can also include a plurality of operable icons to receive input to the UI. Embodiments are not limited to these examples.

In this manner, the UI allows interactions between a user and a virtual POS to occur, e.g., instructions associated with the virtual POS can execute to display the UI on, e.g., a consumer endpoint device. The UI can be implemented by hardware, e.g., in the form of transistor logic and/or application specific integrated circuitry (ASICs), firmware, and software, e.g., in the form of machine readable and executable instructions (program instructions (programming) stored in a machine readable medium (MRM)) which in cooperation can form a computing device. The UI can be configured to receive inputs via a mouse, keyboard, touch screen, track pad, etc., and can represent actions available to a user through graphical icons, visual indicators, and/or sound. Further, the UI can receive inputs resulting from operations performed by computing engines and/or modules, as described above.

In the examples of FIGS. 5A-5C, instructions executed by the virtual POS, e.g. 306 in FIG. 3 and/or the UI can instruct the UI to display, e.g., an actuable UI panel containing a prompt for payment type entry 516. Payment type may be any credit, debit, or ATM card, payment tokens, digital wallet, etc., and may be received via, e.g., a touch pad, touch screen, or keyboard. At 518, instructions associated with the UI can execute to display, e.g., present a prompt to tap the payment card on an NFC enabled input device, e.g., a consumer endpoint device. In various examples, instructions associated with the UI can execute to display, e.g., present a prompt for PIN entry 520 via a PIN entry device (PED), receive PIN entry input; and display a message or messages (e.g., “transaction processing”, “please wait”, etc.) indicating the transaction is being processed 522. Further, instructions associated with the UI can execute to display a message or messages (e.g., “your order has been received”, etc.) indicating a transaction was successful 523. In some examples, the message indicating the transaction was successful 523 can also contain transaction confirmation information, e.g., an order identification number, order reference number, etc.

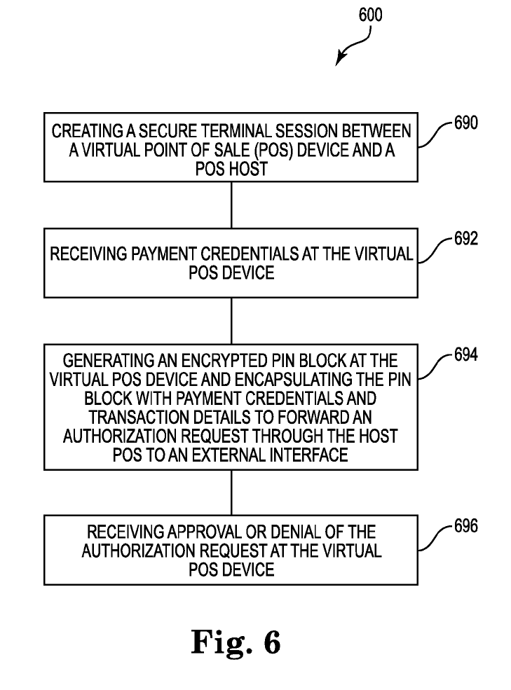

FIG. 6 illustrates a flow chart for a method 600 for electronic funds transfer at a virtual POS according to the present disclosure. In various examples, the method 600 can be performed using the system 100 shown in FIG. 1, or the computing device and modules 201 shown in FIG. 2. Embodiments are not, however, limited to these example systems, devices, and/or modules.

At 690, the method can include creating a secure terminal session between a virtual POS device and a host POS. A secure terminal session can include ensuring validity of the virtual POS device, ensuring message transport encryption, e.g., ANSI x9.52 (3DES), and ensuring message transport authentication, e.g., via a message authentication code (MAC). For example, the merchant web server (450 illustrated in FIG. 4A) can initiate a secure terminal session between the virtual POS device and a host POS by capturing a source IF address, routing virtual POS (terminal) host IF address, and referring to the host POS (e.g., 462 illustrated in FIG. 4). In some examples, creating a secure terminal session between the virtual POS and the host POS can be executed using the engines in FIG. 1 and/or computing device and modules shown in FIG. 2.

At 692, the virtual POS device can receive payment credentials (435 illustrated in FIG. 4). Receipt of payment credentials at the virtual POS device can include tapping a payment card on the virtual POS if the virtual POS device is enabled for NFC communication, or inputting payment credentials manually if the virtual POS device is not enabled for NFC communication. In various examples, as described above, receipt of the payment credentials can be executed using the virtual POS engine 106 and/or virtual POS module 206, illustrated in FIGS. 1 and 2.

At 694, an encrypted PIN block can be generated by the virtual POS device. In various examples, the encrypted PIN block can be created per ANSI x9.8 protocol and ISO 9564. For example, as described above, the encrypted pin block (e.g., 438 illustrated in FIG. 4) can be generated using the ISO 9564 standard. Further, as described above, generating the encrypted PIN block can be executed using the virtual POS engine 106 and/or virtual POS module 206, illustrated in FIGS. 1 and 2. In addition, the merchant engine (e.g., 110 in FIG. 1) and/or the merchant module (e.g., 210 in FIG. 2) can add transaction detail to the encrypted PIN block to complete the ISO 8583 MTI 0100 authorization message. As used herein, transaction detail includes date/time stamp, system trace audit number (STAN), merchant identification number, merchant type information, country code, currency code, etc. or combinations thereof. In various examples, as described above, adding transaction detail with payment credentials to the PIN block can be executed using the virtual POS engine 106 and merchant engine 110 and/or the virtual POS module 206 and merchant engine 210, illustrated in FIGS. 1 and 2. The encrypted PIN block, payment credentials, and transaction detail can be encapsulated within an authorization request (e.g., ISO 8583 MTI 0100) and the authorization request may be forwarded from the virtual POS device through the host POS to the external interface (e.g., 312 in FIG. 3).

At 696, the method 600 can include receiving approval or denial of the authorization request at the virtual POS device. For example, the virtual POS device may receive an MTI 0110 approval message. In addition, the virtual POS device can be configured to display text, graphics, and/or sound indicating approval or denial of the authorization request in response to receiving an approval or denial message.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. For example, reference numeral 102 may refer to element “02” in FIG. 1 and an analogous element may be identified by reference numeral 202 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. Further, as used herein, “a number of” an element and/or feature can refer to one or more of such elements and/or features.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

What is claimed:

1. A non-transitory computer readable medium storing instructions executable by a processing resource to cause a device to:
establish a secure communication session with a virtual point of sale (POS) having a near field communication (NFC) payment capability;
receive an encrypted personal identification number (PIN) block generated at the virtual POS,
forward the encrypted PIN block, payment credentials, and transaction details through the host POS to an external interface in association with a payment authorization request;
communicate a payment authorization notification from the external interface to the virtual POS.

2. The medium of claim 1, wherein the instructions are executable to:
receive a host internet protocol (IP) address and a port number associated with the virtual POS from a merchant in connection with a particular transaction; and
store the host IF address and the port number associated with the virtual POS engine for the particular transaction.

3. The medium of claim 1, wherein the instructions are executable to:
receive merchant credentials; and
send the encrypted PIN block, transaction details, and payment credentials to an external interface in association with the payment authorization request in an ISO 8583 MTI 0100 compliant authorization message.

4. The medium of claim 1, wherein the instructions establish a secure communication session with a virtual POS include instructions which are executable to:
store a Base Derivation Key (BDK),
create a unique Initial PIN Encryption Key (IPEK) from the BDK,
send the IPEK to the virtual POS, and
receive a Derived Unique Key Per Transaction (DUKPT) created from the IPEK and a key serial number stored on the virtual POS.

5. A virtual point of sale (POS) device including logic and firmware to:
create a secure session between the virtual POS device and a host POS,
receive payment credentials according to a near field communication (NFC) compliant protocol at the virtual POS device;
generate an encrypted PIN block at the virtual POS device;
encapsulate the PIN block with payment credentials and transaction details;
send the encapsulated and encrypted PIN block to an external interface in association with a payment authorization request; and
receive approval or denial of the payment authorization request at the virtual POS device.

6. The device of claim 5, wherein the virtual POS device includes:
a personal identification number (PIN) entry device (PED) component that includes at least one of a secure touch screen, secure touch pad, or keyboard; and
a tamper-resistant security module (TRSM) to protect cryptographic security parameters (CSP).

7. The device of claim 5, wherein the logic and firmware to generate the PIN block includes logic and firmware to encrypt the PIN block per ANSI x9.8 and ISO 9564.

8. The device of claim 5, wherein the logic and firmware to create the secure session between the virtual POS device and the host POS device includes logic and firmware to create a Derived Unique Key Per Transaction (DUKPT) from an Initial PIN Encryption Key (IPEK) and key serial number stored on the virtual POS device.

9. The device of claim 8, the logic and firmware to:
receive the IPEK from a host POS, and
send the DUKPT to the host POS.

10. The device of claim 5, wherein the logic and firmware includes logic and firmware to:
add a message authentication code (MAC) at the virtual POS device;
send the MAC to a host POS for decryption; and
receive results from a comparison of the decrypted MAC at the virtual POS device.

11. A non-transitory computer readable medium storing instructions executable by a processing resource to cause a device to:
determine if a virtual point of sale (POS) is near field communication (NFC) enabled;
initialize a communication session between the virtual POS and a host POS, and
establish a host internet protocol (IP) address and a port number associated with the virtual POS engine in a particular online transaction.

12. The medium of claim 11, wherein the instructions are executable to transmit at the host IF address and the port number to the host POS.

13. The medium of claim 11, wherein the particular online transaction is a card present (CP) transaction.

14. The medium of claim 11, wherein the instructions are executable to:
add a date/time stamp, a system trace audit number (STAN), a currency code, a country code, a transaction amount, a merchant type, and a merchant identification in to a personal identification number (PIN) block.

15. The medium of claim 14, wherein the instructions are executable to present the PIN block during a web browsing session host by a merchant web server.
